(19) United States
(12) Patent Application Publication
(10) Pub. No.: US 2025/0363133 A1
(43) Pub. Date: Nov. 27, 2025

(54) METHOD OF CREATING A DATA LABELING SOFTWARE PROGRAM

(71) Applicant: Mastercard International Incorporated, Purchase, NY (US)

(72) Inventors: Cody Maughan, Bountiful, UT (US); Brijesh Garabadu, Sandy, UT (US); Chandra Tupelly, Newark, CA (US); Debapriya Banerjee, Duvall, WA (US); Natesh Babu Arunachalam, Herriman, UT (US); Pavan Teja Nagisetti, South Jordan, UT (US); Satish Bandaru, Scottsale, AZ (US); Saurabh Singh, South Jordan, UT (US)

(73) Assignee: Mastercard International Incorporated, Purchase, NY (US)

(21) Appl. No.: 18/671,635

(22) Filed: May 22, 2024

(51) Int. Cl. G06F 16/28; G06F 16/2458

(52) U.S. Cl. CPC G06F 16/285; G06F 16/2468

(57) ABSTRACT

A method of creating a data labeling software program comprises receiving data packets; randomly selecting a first portion of the data packets; identifying a first set of keywords; creating a first set of rules for the data labeling software program, associating one of a plurality of labels with one or more of the first portion of the data packets according to keywords; executing the data labeling software program to label all of the data packets such that, for each data packet, one of the labels is associated therewith if the data packet includes keywords to which one rule of the first set of rules applies; identifying a second set of keywords; and creating a second set of rules for the data labeling software program, associating one of the labels with at least one of the data packets according to keywords of the second set.

### BACKGROUND OF THE INVENTION

Event-driven data is generated every time an event occurs. The event may include a financial transaction, such as a purchase of goods or services, a payment for a loan or other fee, a paycheck deposit, a credit, and the like. More broadly, the event may include any event about which data may be generated, including naturally occurring phenomena such as weather events, manmade activities such as sporting events, news events, and so on. Each time an event occurs, data describing the event is recorded. Often, the data can be verbose and in the case of a financial transaction, may include information such as a dollar (or other currency) amount, credit or debit, good or service purchased (if the transaction was a purchase), a time and date of the transaction, a location of the transaction, a vendor, a recipient, or an institution, among others. Interested parties, such as financial institutions, may wish to analyze the data to determine large-scale trends in spending or saving or may wish to determine the spending or saving habits of an individual. The interested parties face a major problem in the amount of data to analyze. For a given period of time, tens or hundreds of millions of financial transactions may occur. Given that only a portion of the transactions, such as debits, may be of interest, it would inefficient to have to analyze all of the transactions. Thus, it would be beneficial to have each transaction labeled or categorized with one or more descriptive words in order to easily identify which data is of interest to a particular analysis.

### SUMMARY OF THE INVENTION

Embodiments of the current invention address one or more of the above-mentioned problems and provide methods of creating a data labeling software program. The methods are generalized and may be applied to creating a data labeling software program for labeling data for any event, although exemplary embodiments are applied to labeling financial transactions. One embodiment of the method broadly comprises: receiving a plurality of data packets, each data packet including a plurality of words that describe an event; randomly selecting a first portion of the data packets; identifying a first set of keywords from the first portion of data packets; creating a first set of rules for the data labeling software program, each rule of the first set associating one of a first plurality of labels with one or more of the first portion of the data packets according to one or more keywords in each data packet; executing the data labeling software program to label all of the data packets such that, for each data packet, one of the first plurality of labels is associated therewith if the data packet includes one or more keywords to which one rule of the first set of rules applies; identifying a second set of keywords from the data packets that did not include any keywords of the first set to which one rule of the first set of rules applies; and creating a second set of rules for the data labeling software program, each rule of the second set associating one of a second plurality of labels with at least one of the data packets according to one or more keywords of the second set in each data packet.

Another embodiment of the method broadly comprises: receiving a plurality of data packets, each data packet including a plurality of words that describe an event; randomly selecting a first portion of the data packets; identifying a first set of keywords from the first portion of data packets; creating a first set of rules for the data labeling software program, each rule of the first set associating one of a first plurality of labels with one or more of the first portion of the data packets according to one or more keywords in each data packet; executing the data labeling software program to label all of the data packets such that, for each data packet, one of the first plurality of labels is associated therewith if the data packet includes one or more keywords to which one rule of the first set of rules applies; identifying a second set of keywords from the data packets that did not include any keywords of the first set to which one rule of the first set of rules applies; creating a second set of rules for the data labeling software program, each rule of the second set associating one of a second plurality of labels with at least one of the data packets according to one or more keywords of the second set in each data packet; specifying a priority for each rule of the first set of rules and the second set of rules such that rules with a higher priority are applied before rules with a lower priority; and specifying additional conditions for each rule of the first set of rules and the second set of rules for the data packet to meet before the associated rule is applied.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a listing of at least a portion of the steps of a method of creating a data labeling program;

FIG. 2 is a perspective view of a plurality of computing devices, each configured to carry out at least some of the steps of the method; and

FIG. 3 is a schematic block diagram depicting at least some of the electronic components of the computing device.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

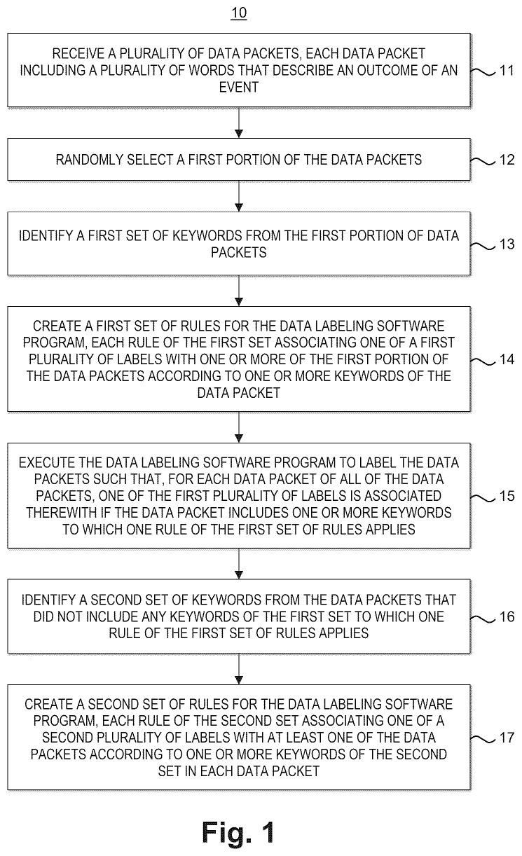

The steps of an exemplary method 10 for creating a data labeling software program is shown in FIG. 1. The data labeling software program is configured to receive a plurality of data packets as input and, for each data packet, associate a label with the data packet. The data packet, as discussed in more detail below, includes a plurality of words that describe an event or an outcome of the event. The label includes one or more words which describe the contents of the data packet.

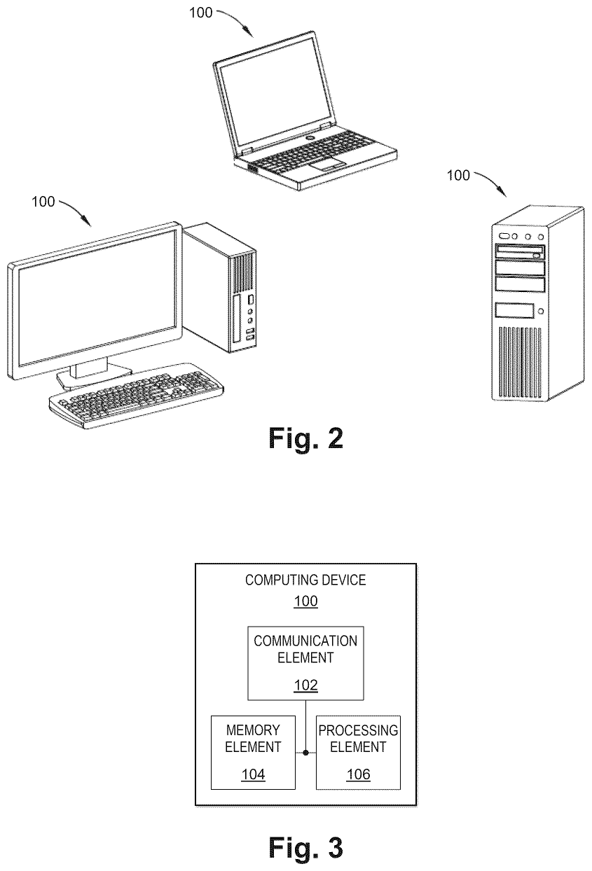

At least a portion of the steps of the method 10 are performed by a computing device 100, as shown in FIG. 2. The computing device 100 may be embodied by one or more servers, high performance computers, workstation computers, desktop computers, laptop computers, palmtop computers, notebook computers, tablets or tablet computers, and so forth. In addition as shown in FIG. 3, the computing device 100 comprises a communication element 102, a memory element 104, and a processing element 106. The computing device 10 may further comprise other components, such as a monitor, display, or touchscreen, a keyboard or keypad, a mouse, and so forth which will not be discussed herein in detail.

The communication element 102 generally allows the computing device 100 to communicate with other computing devices, external systems, computing networks, telecommunication networks, the Internet, and the like. The communication element 102 may include signal and/or data transmitting and receiving circuits, such as antennas, amplifiers, filters, mixers, oscillators, digital signal processors (DSPs), and the like. The communication element 102 may establish communication wirelessly by utilizing radio frequency (RF) signals and/or data that comply with communication standards such as cellular 2G, 3G, 4G, Voice over Internet Protocol (VOIP), LTE, Voice over LTE (VOLTE), or 5G, Institute of Electrical and Electronics Engineers (IEEE) 802.11 standard such as WiFi, IEEE 802.16 standard such as WiMAX, Bluetooth™, or combinations thereof. In addition, the communication element 102 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 102 may establish communication through connectors or couplers that receive metal conductor wires or cables which are compatible with networking technologies such as ethernet. In certain embodiments, the communication element 102 may also couple with optical fiber cables. The communication element 102 may be in electronic communication with the memory element 104 and the processing element 106.

The memory element 104 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element 104 may be embedded in, or packaged in the same package as, the processing element 106. The memory element 104 may include, or may constitute, a non-transitory “computer-readable medium”. The memory element 104 may store the instructions, code, code statements, code segments, software, firmware, programs, applications, apps, services, daemons, or the like that are executed by the processing element 106. The memory element 104 is in electronic communication with the processing element 106 and may also store data that is received by the processing element 106 or the device in which the processing element 106 is implemented. The processing element 106 may further store data or intermediate results generated during processing, calculations, and/or computations as well as data or final results after processing, calculations, and/or computations. In addition, the memory element 104 may store settings, text data, documents from word processing software, spreadsheet software and other software applications, sampled audio sound files, photograph or other image data, movie data, databases, and the like.

The processing element 106 may comprise one or more processors. The processing element 106 may include electronic hardware components such as microprocessors (single-core or multi-core), microcontrollers, digital signal processors (DSPs), field-programmable gate arrays (FPGAs), analog and/or digital application-specific integrated circuits (ASICs), intelligence circuitry, or the like, or combinations thereof. The processing element 106 may generally execute, process, or run instructions, code, code segments, code statements, software, firmware, programs, applications, apps, processes, services, daemons, or the like. The processing element 106 may also include hardware components such as registers, finite-state machines, sequential and combinational logic, configurable logic blocks, and other electronic circuits that can perform the functions necessary for the operation of the current invention. In certain embodiments, the processing element 106 may include multiple computational components and functional blocks that are packaged separately but function as a single unit. In some embodiments, the processing element 106 may further include multiprocessor architectures, parallel processor architectures, processor clusters, and the like, which provide high performance computing. The processing element 106 may be in electronic communication with the other electronic components of the computing device 100 through serial or parallel links that include universal busses, address busses, data busses, control lines, and the like. In addition, the processing element 106 may include ADCs to convert analog electronic signals to (streams of) digital data values and/or digital to analog converters (DACs) to convert (streams of) digital data values to analog electronic signals.

The processing element 106 may be operable, configured, and/or programmed to perform at least a portion of the functions, operations, processes, methods, and/or algorithms of the current invention by utilizing hardware, software, firmware, or combinations thereof. Other components, such as the communication element 102 and the memory element 104 may be utilized as well.

Variations to the steps of the method 10 may be performed. The steps may be performed in the order shown in FIG. 3, or they may be performed in a different order. Furthermore, some steps may be performed concurrently as opposed to sequentially. In addition, some steps may be optional or may not be performed. Some of the steps may be performed by the processing element 106 of the computing device 100. Also, the steps may be implemented as instructions, code, code segments, code statements, a program, an application, an app, a process, a service, a daemon, or the like, and may be stored on a computer-readable storage medium, such as the memory element 104. Other steps may be performed by human programmers utilizing the computing device 100.

Referring to step 11, a plurality of data packets is received, with each data packet including a plurality of words that describe an outcome of an event. Each data packet may also include one or more numerical values and/or alphanumerical values. In exemplary embodiments, each data packet may describe a single financial transaction and may include information such as a dollar (or other currency) amount, whether the transaction was a credit or debit, good or service purchased (if the transaction was a purchase), a time and date of the transaction, a location of the transaction, a vendor or retailer, a recipient or purchaser, an account number, and an institution, among others, wherein each piece of information may be considered a field and includes text, numerical values and/or alphanumerical values. Examples of the financial transaction include the purchase of goods at a store (online or in-person), the purchase of food at a dining establishment, the purchase of services from a contractor, the payment of a bill, the deposit of a check, a payroll deposit, and the like.

The description of the transaction, that is, the data packet, is received from banks, credit card companies, retailers, online service providers, medical facilities, and so forth. The data packets are typically received through electronic communication networks such as the Internet or telecommunications networks. The data packets may be received in near real time, or may be received on a periodic basis, such as hourly, daily, weekly, etc. In some instances, the number of data packets received may total in the millions or tens of millions for a given period of time.

Referring to step 12, a first portion of the data packets is randomly selected. The first portion may represent a percentage, such as 10%, of the total data packets received or a fixed number, such as 10,000. Statistical rules or practices may be followed in order to select a representative sample of the data packets.

Referring to step 13, a first set of keywords is identified from the first portion of the data packets. The numerical values or alphanumerical values may be ignored, given less consideration, or removed. Each data packet is parsed and analysis techniques such as n-gram analysis, regular expression (regex) analysis, fuzzy matching, and the like. N-gram analysis typically involves sequentially grouping the text of the data packet into n-word clusters, where n is an integer value. As an example, if n=2, then the first word and the second word would be grouped, the third word and the fourth word would be grouped, and so forth. Regex analysis typically involves searching the text of the data packet for a string of characters, wherein the characters may vary. Fuzzy matching typically involves searching for variations of a particular term, wherein the variations may include different spellings of a word, the inclusion of spaces or dashes, and the like. The analysis techniques identify words or sets of words that are common or repeated in a plurality of data packets. Those words or sets of words are considered keywords. Those data packets that include the same or similar keywords are grouped together.

Referring to step 14, a first set of rules for the data labeling software program is created. Creation of the rules may be performed by one or more human programmers. Or, the rules may be created, in part or in their entirety, by artificial intelligence techniques or software. The data labeling software program includes at least the first set of rules. The data labeling software program may also include additional sets of rules as well as code that performs other tasks. The data labeling software program may be written in any suitable programming language. Exemplary embodiments of at least the rules of the data labeling software program may be written in JavaScript object notation (json).

Each rule of the first set associates one of a first plurality of labels with one or more of the first portion of the data packets according to one or more keywords of the data packet. Each rule looks for one or more of the keywords and then associates a label with the data packet which varies according to the keywords. For example, a first rule may search the data packet for a first keyword and associate a first label with the data packet if the first keyword is found. A second rule may search the data packet for a second keyword and associate a second label with the data packet if the second keyword is found, and so forth with successive rules, keywords, and labels.

In some instances, a plurality of rules may search the data packet for variations of spellings of a particular keyword and associate a label accordingly. For example, a first rule may search the data packet for a first variation of a keyword, a second rule may search for a second variation of the keyword, and so forth. Each rule may associate the same label with the data packet if any of the variations of the keyword are found.

In other instances, a plurality of rules may search the data packet for the same one or more keywords and associate different labels with the data packet according to priorities and additional conditions of the data packet. The priority is a numerical value that may be specified or assigned by human programmers, software algorithms, or artificial intelligence. The priority provides a rank for each rule that searches for the same one or more keywords. Rules with a higher priority, i.e., a lower numerical value, are applied before those with a lower priority, assuming the additional conditions are met. The additional conditions include Boolean (true/false) statements and may check relational conditions such as greater than, equal to, etc., which can be used to determine the sign (positive or negative) and range of values of numbers. Other additional conditions may check for secondary keywords. All of the additional conditions for a given rule must be met, i.e., the Boolean statements must be true, before the rule is applied. For example, a first rule, with a highest priority, may search the data packet for a first one or more keywords and associate a first label with the data packet if the first one or more keywords is found and a first set of conditions is met. A second rule, with a second highest priority, may search the data packet for the first one or more keywords and associate a second label with the data packet if the first keyword is found and a second set of conditions is met. Specifically, in one instance, a plurality of rules may search a particular data packet for the keyword “payment”. A first rule may associate the label “mortgage” with the data packet if the keyword “payment” is included and a first set of conditions is met. A second rule may associate the label “loan payments” with the data packet if the keyword “payment” is included and a second set of conditions is met. A third rule may associate the label “credit card payments” with the data packet if the keyword “payment” is included and a third set of conditions is met. A fourth rule may associate the label “income” with the data packet if the keyword “payment” is included and a fourth set of conditions is met. The process may continue with successive rules, labels, conditions, and the same one or more keywords.

Each label identifies and/or categorizes the data packet with one or more descriptive words. For example, a data packet resulting from a payment for advertising services may be labeled “advertising”, according to the keyword content and the corresponding rules. A data packet resulting from a payment to an airline for airfare or to the transportation safety administration (TSA) for air travel related expenses or general air travel fees may be labeled “air travel”. A data packet resulting from a payment at a bar or nightclub may be labeled “alcohol & bars”. Other data packets are labeled similarly according to the contents or keywords included therein and the appropriate rules. The first plurality of labels may include dozens of labels, e.g., up to one hundred or more.

The first set of rules is integrated into the data labeling software program. Typically, each data packet is analyzed by the data labeling software program one at a time, wherein keywords are searched for and one or more rules are applied appropriately to associate a label with the data packet. The data labeling software program may forward, or communicate, the data packet and its associated label to an external system or entity. Alternatively, or additionally, the data labeling software program may include, may output, or may have access to, a database, or other data store, which stores each data packet, or a pointer to each data packet, along with the label for each data packet.

Referring to step 15, the data labeling software program is executed and receives all of the data packets—not just the first portion of the data packets, which were used to create the first set of rules. The data labeling software program runs as discussed above and the first set of rules is applied to associate, assign, or tag each of the data packets with one of the labels according to the keywords, priorities, and additional conditions. However, the entire set of data packets often includes a second portion of data packets which does not have any keywords to which any of the first set of rules applies. These data packets are flagged as unlabeled and are not forwarded externally or stored in a database with a label.

Referring to step 16, a second set of keywords is identified from the data packets that did not include any keywords of the first set to which one rule of the first set of rules applies, i.e., the second portion of data packets. The keywords are identified and then a second plurality of labels is associated, assigned, or tagged to each data packet of the second portion according to the (new) keywords in the data packet. The second plurality of labels may include some or all of the first plurality of labels, additional labels, or combinations thereof. Similar techniques may be utilized that were used in step 13. This step may be performed manually by human programmers utilizing analysis techniques such as n-gram analysis, regex analysis, fuzzy matching, and the like.

Referring to step 17, a second set of rules for the data labeling software program is created. Each rule of the second set associates one of the second plurality of labels with at least one of the data packets according to one or more keywords of the second set in each data packet. The second set of rules is similar to the first set and includes priorities and additional conditions, but the rules are applied when one of the second set of keywords is present in the data packet.

The second set of rules is integrated into the data labeling software program, which may be executed for normal operation. That is, the data labeling software program receives a plurality of data packets and associates, assigns, or tags each of the data packets with one of the labels according to the keywords, priorities, and additional conditions. It is possible that some of the data packets do not include keywords that have already been identified and thus, will not be labeled. In that case, steps 16 and 17 may be performed again in order to create rules that will label those packets which have gone unlabeled. In fact, steps 16 and 17 can be repeated as necessary.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method of creating a data labeling software program, the method comprising:
receiving a plurality of data packets, each data packet including a plurality of words that describe an event;
randomly selecting a first portion of the data packets;
identifying a first set of keywords from the first portion of data packets;
creating a first set of rules for the data labeling software program, each rule of the first set associating one of a first plurality of labels with one or more of the first portion of the data packets according to one or more keywords in each data packet;
executing the data labeling software program to label all of the data packets such that, for each data packet, one of the first plurality of labels is associated therewith if the data packet includes one or more keywords to which one rule of the first set of rules applies;
identifying a second set of keywords from the data packets that did not include any keywords of the first set to which one rule of the first set of rules applies; and
creating a second set of rules for the data labeling software program, each rule of the second set associating one of a second plurality of labels with at least one of the data packets according to one or more keywords of the second set in each data packet.

2. The method of claim 1, wherein identifying the first set of keywords includes sorting the first portion of the data packets into groups such that each group of data packets includes the same or similar keywords.

3. The method of claim 1, wherein identifying the second set of keywords includes sorting the second portion of the data packets into groups such that each group of data packets includes the same or similar keywords.

4. The method of claim 1, wherein identifying the first set of keywords includes n-gram analysis of the text of each data packet of the first portion.

5. The method of claim 1, wherein identifying the second set of keywords includes n-gram analysis of the text of each data packet of the second portion.

6. The method of claim 1, wherein identifying the first set of keywords includes regular expression analysis of the text of each data packet of the first portion.

7. The method of claim 1, wherein identifying the second set of keywords includes regular expression analysis of the text of each data packet of the second portion.

8. The method of claim 1, wherein identifying the first set of keywords includes fuzzy matching of the text of each data packet of the first portion.

9. The method of claim 1, wherein identifying the second set of keywords includes fuzzy matching of the text of each data packet of the second portion.

10. The method of claim 1, wherein creating the first set of rules and creating the second set of rules each includes specifying a priority for each rule such that rules with a higher priority are applied before rules with a lower priority.

11. The method of claim 1, wherein creating the first set of rules and creating the second set of rules each includes specifying additional conditions for each rule for the data packet to meet before the associated rule is applied.

12. The method of claim 1, wherein creating the first set of rules and creating the second set of rules each includes specifying variations of spellings of one or more keywords for at least a portion of each set of rules.

13. The method of claim 1, further comprising integrating the first set of rules and the second set of rules into the data labeling software program.

14. A method of creating a data labeling software program, the method comprising:
receiving a plurality of data packets, each data packet including a plurality of words that describe an event;
randomly selecting a first portion of the data packets;
identifying a first set of keywords from the first portion of data packets;
creating a first set of rules for the data labeling software program, each rule of the first set associating one of a first plurality of labels with one or more of the first portion of the data packets according to one or more keywords in each data packet;
executing the data labeling software program to label all of the data packets such that, for each data packet, one of the first plurality of labels is associated therewith if the data packet includes one or more keywords to which one rule of the first set of rules applies;
identifying a second set of keywords from the data packets that did not include any keywords of the first set to which one rule of the first set of rules applies;
creating a second set of rules for the data labeling software program, each rule of the second set associating one of a second plurality of labels with at least one of the data packets according to one or more keywords of the second set in each data packet;
specifying a priority for each rule of the first set of rules and the second set of rules such that rules with a higher priority are applied before rules with a lower priority; and
specifying additional conditions for each rule of the first set of rules and the second set of rules for the data packet to meet before the associated rule is applied.

15. The method of claim 14, wherein identifying the first set of keywords includes n-gram analysis of the text of each data packet of the first portion, regular expression analysis of the text of each data packet of the first portion, fuzzy matching of the text of each data packet of the first portion, and sorting the first portion of the data packets into groups such that each group of data packets includes the same or similar keywords.

16. The method of claim 14, wherein identifying the second set of keywords includes n-gram analysis of the text of each data packet of the second portion, regular expression analysis of the text of each data packet of the second portion, fuzzy matching of the text of each data packet of the second portion, and sorting the second portion of the data packets into groups such that each group of data packets includes the same or similar keywords.
